(19) United States
(12) Patent Application Publication
(10) Pub. No.: US 2022/0358555 A1
(43) Pub. Date: Nov. 10, 2022

(54) Method for Providing Item Information and an Apparatus for the Same

(71) Applicant: Coupang Corp., Seoul (KR)

(72) Inventors: Jee Hyun Bae, Seoul (KR); Hae Yeon Lee, Seoul (KR); Yun Jeong Choi, Seoul (KR); Da Young Lee, Seoul (KR)

(73) Assignee: Coupang Corp., Seoul (KR)

(21) Appl. No.: 17/394,817

(22) Filed: Aug. 5, 2021

(30) Foreign Application Priority Data
May 7, 2021 (KR) 10-2021-0059350

(51) Int. Cl. G06Q 30/06

(52) U.S. Cl. CPC G06Q 30/0623; G06Q 30/0641

(57) ABSTRACT

A method of providing item information according to some example embodiments may include at least one of checking information on a main item according to a first input, identifying at least one additional item related to the main item, checking information on the at least one additional item, providing a first page including a first area containing the information on the main item, a second area containing the information on the at least one additional item, and a third area containing a first interface related to item purchase, identifying one or more additional items selected from the at least one additional item based on a second input corresponding to the second area, and providing information related to a purchase of a set item including the main item and the selected one or more additional items based on a third input corresponding to the first interface.

### TECHNICAL FIELD

The following descriptions relate to a method and an apparatus for providing item information and, more specifically, to a method and an apparatus for providing item information in which a user is provided in an easy-to-understand manner with other items related to an item the user wants to purchase or other items to which a discount is applied if purchased together and the user can purchase them as a set or add them to the shopping cart to effectively proceed with a purchase process.

### DESCRIPTION OF THE RELATED ART

In an internet shopping mall, a user can select a desired item and purchase the selected item. Also, in general, when items are sold, there are other items to which a discount is applied if purchased together with a specific item in order to promote the purchase intention of the consumer.
Prior document: Korean Patent Publication No. 10-2006-0032376

The user may purchase only the specific item searched for by the user, but may wish to purchase other items related to the specific item at once. In addition, if there are other items to which a discount is applied when purchasing together with a specific item, it is difficult for consumers to know such information online. If the user has to search, inquire, and purchase the main item and other related items one by one, this may not only cause unnecessary burden and inconvenience to the user, but also may not promote purchase demand for other items.

### DISCLOSURE OF THE INVENTION

An aspect of the present disclosure provides a method and an apparatus for providing item information capable of solving the above issues. Specifically, an aspect of the present disclosure provides a method and an apparatus for providing item information in which, when a user selects or inquires an item to purchase, items to which a discount applies when purchasing together with the item or other items closely related to the item are presented to the user together to purchase them in a set unit.

The technical aspects of the present disclosure are not limited to those mentioned above, and other aspects can be inferred from the following example embodiments.

According to an aspect, there is provided a method of providing item information, the method including at least one of checking information on a main item according to a first input, identifying at least one additional item related to the main item, checking information on the at least one additional item, providing a first page including a first area containing the information on the main item, a second area containing the information on the at least one additional item, and a third area containing a first interface related to item purchase, identifying one or more additional items selected from the at least one additional item based on a second input corresponding to the second area, and providing information related to a purchase of a set item including the main item and the selected one or more additional items based on a third input corresponding to the first interface.

Further, the method may further include changing information displayed on the interface related to the purchase in response to the identification of the selected one or more additional items.

Furthermore, the information related to the purchase of the set item according to some example embodiments may include information related to delivery of items in the set item, and the information related to the delivery of the items may be displayed separately for each item.

Further, the information related to the purchase of the set item according to some example embodiments may be displayed in a fourth area displayed on the first page, and the fourth area may include a second interface for payment of the set item and a third interface for adding the set item to a cart list.

Further, the checking of the information on the at least one additional item may include at least one of checking promotion identification information related to the main item, and identifying the at least one additional item having promotion identification information corresponding to the promotion identification information.

In addition, the method may further include setting a relation key corresponding to the set item including the main item and the selected one or more additional items in response to the third input.

In addition, in the method, a value of the relation key may be updated in response to a fourth input related to change of the additional items by a user, and a relation key different from the relation key may be set in response to a fifth input related to a purchase of a set item different from the set item.

In addition, the method may further include providing a terminal of a user with a second page for a purchase of a plurality of set items including the set item, and the second page may display the set items having different relation key values to be discriminated.

Further, the method may add the set item to a shopping cart list based on the relation key, in response to a sixth input of a user.

Further, the first page according to some example embodiments may include a check box for selecting each additional item.

Further, the method may further include providing a terminal of a user with a third page for displaying sets included in the shopping cart list in response to a seventh input, and the third page may display the set items having different relation key values to be discriminated.

Further, the second page according to some example embodiments may include first information indicating a first price that is a sum of a price of the main item and a price of the at least one additional item, and second information indicating a second price to which a set discount is applied to the first price.

Furthermore, the second page according to some example embodiments may further include third information indicating a difference between the first price and the second price.

Furthermore, the second page according to some example embodiments may include an interface for the user to adjust a purchase quantity of the set item.

Furthermore, the information on the at least one additional item according to some example embodiments may include information indicating a price to which a discount applied at the time of purchase for each additional item is applied.

In addition, the first page according to some example embodiments may display the at least one additional item to be arranged in a specific order, and the specific order may be determined based on a degree of a discount applied at the time of purchase for each additional item.

In addition, the method may further include at least one of checking bundle identification information for discriminating items having the same promotion identification information value, identifying a specific number of items in the order of items with high sales volume among the items included in the bundle identification information, and providing information on the identified specific number of items to a terminal of a user.

According to example embodiments, a method of providing item information may provide necessary information on items to a user without the user inquiring or searching for other items related to a specific item individually, thereby reducing unnecessary burden on the user and eliminating the user's inconvenience.

According to example embodiments, a method of providing item information may increase the purchase demand for items related to or derived from the main item.

According to example embodiments, a method of providing item information allows users to understand at a glance what other items are required to utilize the main item when purchasing the main item, thereby effectively delivering necessary items to consumers.

According to example embodiments, a method of providing item information may avoid confusion for users who want to purchase items in bulk in a set unit, and reduce the inconvenience of the user in calculating and determining the quantity of individual items one by one. Therefore, it is possible to prevent a purchase caused by a user's mistake.

### BRIEF DESCRIPTION OF THE DRAWINGS

FIG. 1 illustrates an example of internal components of an electronic apparatus according to example embodiments.

FIG. 2 is a flowchart illustrating an example of a method of providing item information according to example embodiments.

FIG. 3 is a diagram illustrating a relationship between a main item according to some example embodiments and additional items according to example embodiments.

FIG. 4 is a flowchart illustrating an example of a method of providing item information according to example embodiments.

FIG. 5 is a flowchart illustrating an example of a method of providing item information according to example embodiments.

FIG. 6 is a flowchart illustrating an example of a method of providing item information according to example embodiments.

FIG. 7 illustrates an example of a first page according to example embodiments.

FIG. 8 illustrates an example of a first page according to example embodiments.

FIG. 9 illustrates an example of a first page according to example embodiments.

FIG. 10 illustrates an example of a first page according to some example embodiments and a third page showing a shopping cart list according to example embodiments.

### DETAILED DESCRIPTION OF THE INVENTION

Hereinafter, example embodiments of the present disclosure are described in detail with reference to the accompanying drawings.

Detailed descriptions of technical specifications well-known in the art and unrelated directly to the present disclosure may be omitted to avoid obscuring the subject matter of the present disclosure. This aims to omit unnecessary description so as to make clear the subject matter of the present disclosure.

For the same reason, some elements are exaggerated, omitted, or simplified in the drawings and, in practice, the elements may have sizes and/or shapes different from those shown in the drawings. Throughout the drawings, the same or equivalent parts are indicated by the same reference numbers

Advantages and features of the present disclosure and methods of accomplishing the same may be understood more readily by reference to the following detailed description of example embodiments and the accompanying drawings. The present disclosure may, however, be embodied in many different forms and should not be construed as being limited to the example embodiments set forth herein. Rather, these example embodiments are provided so that this disclosure will be thorough and complete and will fully convey the concept of the disclosure to those skilled in the art, and the present disclosure will only be defined by the appended claims. Like reference numerals refer to like elements throughout the specification.

It will be understood that each block of the flowcharts and/or block diagrams, and combinations of blocks in the flowcharts and/or block diagrams, can be implemented by computer program instructions. These computer program instructions may be provided to a processor of a general-purpose computer, special purpose computer, or other programmable data processing apparatus, such that the instructions which are executed via the processor of the computer or other programmable data processing apparatus create means for implementing the functions/acts specified in the flowcharts and/or block diagrams. These computer program instructions may also be stored in a non-transitory computer-readable memory that can direct a computer or other programmable data processing apparatus to function in a particular manner, such that the instructions stored in the non-transitory computer-readable memory produce articles of manufacture embedding instruction means which implement the function/act specified in the flowcharts and/or block diagrams. The computer program instructions may also be loaded onto a computer or other programmable data processing apparatus to cause a series of operational steps to be performed on the computer or other programmable apparatus to produce a computer implemented process such that the instructions which are executed on the computer or other programmable apparatus provide steps for implementing the functions/acts specified in the flowcharts and/or block diagrams.

Furthermore, the respective block diagrams may illustrate parts of modules, segments, or codes including at least one or more executable instructions for performing specific logic function(s). Moreover, it should be noted that the functions of the blocks may be performed in a different order in several modifications. For example, two successive blocks may be performed substantially at the same time, or may be performed in reverse order according to their functions.

According to various embodiments of the present disclosure, the term “module”, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and be configured to be executed on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more CPUs in a device or a secure multimedia card.

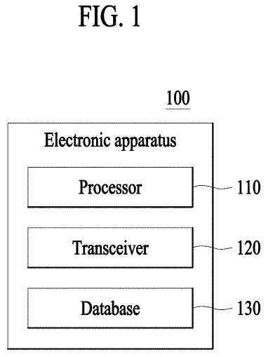

FIG. 1 illustrates examples of internal components of an electronic apparatus according to example embodiments.

Referring to FIG. 1, internal components of an electronic apparatus 100 are not limited to those illustrated. The electronic apparatus 100 may include at least one of a processor 110, a transceiver 120, and a storage part 130.

The processor 110 may process a series of operations for performing a method for providing item information according to various example embodiments of the present disclosure. The processor 110 may control other components of the electronic apparatus 100. Meanwhile, in an example embodiment, a product may be used as a term referring to a specific item, and the item may be sold to a user in a service related to the electronic apparatus 100.

The processor 110 may check detailed information about a first item in response to a request of a first page for the first item. When the processor 110 checks through the storage part 130 whether the first item is included in a specific category, the processor 110 may identify at least one second item corresponding to the specific category. The processor 110 may check at least one attribute list corresponding to the specific category.

The attribute list may be previously stored in the storage part 130 or may be received from the outside through the transceiver 120. The processor 110 may provide the first page to a display of the electronic apparatus 100. The first page may include a first part in which detailed information about the first item is provided, a second part in which first attribute information of the first item corresponding to the attribute list is provided, and a third part in which second attribute information of at least one second item corresponding to the attribute list is provided.

The transceiver 120 may perform functions of transmitting information stored in the storage part 130 of the electronic apparatus 100 or information processed by the processor 110 to another apparatus or receiving information from another apparatus to the electronic apparatus 100.

The storage part 130 is a data structure implemented in a predetermined storage space of the electronic apparatus 100, and functions such as storing, searching, deleting, editing, or adding data may be freely performed. For example, the storage part 130 may have fields or elements for processing functions such as storing, searching, deleting, editing, or adding data. The storage part 130 may store data related to performing information providing method by the electronic apparatus 100. For example, the storage part 130 may store instructions or data for an execution operation of the processor 110.

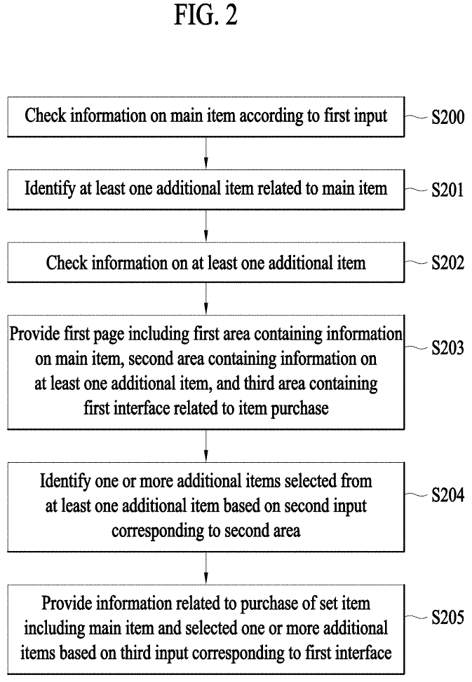

FIG. 2 is a flowchart illustrating an example of a method of providing item information according to example embodiments.

Some or all of the operations shown in FIG. 2 may be performed by the electronic apparatus 100 or the processor 110 in the electronic apparatus 100 according to some example embodiments shown in FIG. 1. Referring to FIG. 2, the apparatus for providing item information according to some example embodiments may perform some or all of operations S200 to S205. Hereinafter, the apparatus for providing item information according to some example embodiments will be referred to as the electronic apparatus according to example embodiments.

Referring to operation S200, the electronic apparatus according to some example embodiments may check information on a main item according to a first input.

The first input may be an input for searching and inquiring the main item according to example embodiments. For example, the first input may include a user input for retrieving information on the main item.

The main item may be an item or product according to some example embodiments that the user intends to purchase. The main item means a main product that the user wants to purchase. That is, the user transmits the first input to the electronic apparatus to purchase the main item, and the electronic apparatus according to some example embodiments confirms the first input. The main item may be referred to as a primary item, a major item, or the like.

Referring to operation S201, the electronic apparatus according to some example embodiments may identify at least one additional item related to the main item.

The user may, for example, purchase only the main item, but may wish to purchase other items related to the main item at once. However, if the user has to separately search for, inquire, and purchase the main item and other related items, this may not only cause unnecessary burden and inconvenience to the user, but also may not promote purchase demand for other items.

Accordingly, when a user wants to purchase the main item, the electronic apparatus according to some example embodiments needs to show other items related to the main item at a glance. Accordingly, the electronic apparatus according to some example embodiments may identify at least one additional item in order to provide the user with the at least one additional item related to the main item.

The additional item according to some example embodiments may be an item related to the main item. The additional item may be, for example, a sub-item of the main item, or an item required together with the main item. For example, when the main item is a computer product, the additional item may include an electric wire included in the computer required for the operation of the computer product, computer parts, computer accessories, and the like. For example, the additional item may be an item associated with a computer product and may include a mouse, a keyboard, and the like. The additional item may be referred to as a secondary item, an accompanying item, or the like.

The additional item according to some example embodiments may mean an item to which a discount benefit (or promotion) can be applied when purchased together with the main item. That is, when the user purchases the additional item together with the main item, the additional item may be an item to which a discount is applied to the main item and the additional item.

The additional items according to some example embodiments may be referred to as bundled items, bundled products, and the like.

The additional item may be an item that is often sold together with the main item. For example, the electronic apparatus according to some example embodiments may first check the main item, check the purchase record in which the main item is sold, check other items sold together with the main item in the purchase record, and then determine the frequently sold item among them as the additional item.

The electronic apparatus according to some example embodiments may store promotion identification information for linking the main item and the additional item for each item. For example, when the first item and the second item have the same promotion identification information value, the first item and the second item have a relationship of the main item and the additional item with each other. For example, if the user selects the first item as the main item, the electronic apparatus according to some example embodiments may determine the second item as the additional item and present the additional item to the user. That is, each item may have promotion identification information, and, when the main item is selected by the user, the electronic apparatus according to some example embodiments may search for additional items having the same value of promotion identification information as the value of the promotion identification information of the main item, and present the retrieved additional items to the user.

Referring to operation S202, the electronic apparatus according to some example embodiments may check information on the at least one additional item.

The electronic apparatus according to some example embodiments may check information on the retrieved additional items in operation S201. The information on the additional item may include, for example, a name of each additional item, information related to a description of each additional item, a price of each additional item, information related to a discount of the additional item, and a category of the additional item.

Referring to operation S203, the electronic apparatus according to some example embodiments may provide a first page including a first area containing information on the main item, a second area containing information on the at least one additional item, and a third area containing a first interface related to item purchase (or a first interface).

The first page may be a page for displaying detailed descriptions of the main item according to example embodiments. The first page may be variously called an item detail page, a product detail page, a product information page, and the like.

The first page may include, for example, at least one of the first to third areas according to example embodiments. The first area according to some example embodiments contains the information on the main item. For example, the first area contains a name of the main item, information related to a description of the main item, a price of the main item, information related to a discount of the main item, a category of the main item, and information related to a review of the main item. The second area according to some example embodiments contains the information on the at least one additional item related to the main item. The third area may contain the first interface related to the item purchase (or the first interface). The third area may further contain a second interface for adding an item to the shopping cart list.

Referring to operation S204, the electronic apparatus according to some example embodiments may identify one or more additional items selected from the at least one additional item based on a second input corresponding to the second area.

The second input according to some example embodiments may include an input for selecting one or more additional items from the at least one additional item related to the main item. For example, if there are five additional items related to the main item, and the user selects one or more additional items among them, the second input may be an input related to the item selected by the user. The electronic apparatus according to some example embodiments identifies one or more additional items selected by the user, according to the second input.

The second input according to some example embodiments may be received within the second area according to example embodiments. For example, when the user clicks a specific additional item in the second area within the first page, the second input may be an input for selecting the corresponding additional item. For example, when the user performs a slide gesture in an area indicating a specific additional item in the second area in the first page, the second input may be an input for selecting the corresponding additional item.

Referring to operation S205, information related to a purchase of a set item including the main item and the selected one or more additional items may be provided based on a third input corresponding to the first interface according to example embodiments.

The third input is an input corresponding to the first interface according to example embodiments. For example, when the user clicks on the first interface, the electronic apparatus according to some example embodiments may provide the user with information for purchasing the set item including the item and the selected one or more additional items according to the third input.

The set item may be a set of items including the main item that the user wants to purchase and the one or more additional items selected by the user in operation S204.

The electronic apparatus according to some example embodiments may classify the set item into one unit item and provide the user with an item purchase procedure. For example, the electronic apparatus according to some example embodiments may regard the set item including the main item and the additional items selected by the user as one item unit, and inquire about the purchase quantity of the set item to the user.

Also, when the additional item is different even though the main item is the same, the electronic apparatus according to some example embodiments may differentiate them into different set items and provide the user with the item purchase procedure. For example, the electronic apparatus according to some example embodiments considers a first set including one main item and one first additional item and a second set including one main item and two second additional items to be different items from each other, and enables the user to manage the item purchase quotation on a set basis.

In order to provide such a function, the electronic apparatus according to some example embodiments may generate relation identification information for identifying a set item. The relation identification information may include, for example, identification information on a set item that the user wants to purchase.

For example, when a user selects or purchases a set item including a main item and one or more additional items, the electronic apparatus according to some example embodiments may generate the relation identification information for identifying the corresponding set. When the user adds, deletes, or changes some additional items in the set, the generated relation identification information may be changed.

For example, when the first set includes one main item and one first additional item, and the second set includes one main item and two second additional items, a value of the relation identification information for the first set may be different from a value of the relation identification information for the second set. Here, when the user deletes the second additional item included in the second set and adds the first additional item, the second set becomes the same as the first set, and the relation identification information of the second set may be the same as the relation identification information of the first set.

In the above-described configuration, the electronic apparatus according to some example embodiments may avoid confusion for users who want to purchase items in bulk in a set unit, and reduce the inconvenience of the user in calculating and determining the quantity of individual items one by one. Therefore, it is possible to prevent a purchase caused by a user's mistake.

In the above-described configuration, the electronic apparatus according to some example embodiments may provide necessary information on items to the user without the user inquiring or searching for other items related to a specific item individually, thereby reducing unnecessary burden on the user and eliminating the user's inconvenience.

Further, in the above-described configuration, the electronic apparatus according to some example embodiments may increase the purchase demand for items related to or derived from the main item.

Furthermore, in the above-described configuration, the electronic apparatus according to some example embodiments allows users to understand at a glance what other items are required to utilize the main item when purchasing the main item, thereby effectively delivering necessary items to consumers.

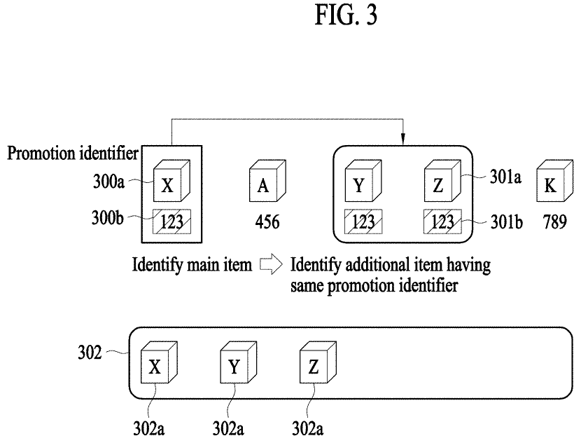

FIG. 3 is a diagram illustrating a relationship between a main item according to some example embodiments and additional items according to example embodiments.

Some or all operations according to some example embodiments shown in FIG. 3 may be performed in the electronic apparatus according to some example embodiments shown in FIGS. 1 and 2.

Referring to FIG. 3, the item may have promotion identification information for identifying additional items related to the corresponding item. For example, the first item may have promotion identification information for the first item to identify additional items related to the first item. That is, the specific item and at least one item related to the specific item may have the same promotion identification information.

The electronic apparatus according to some example embodiments checks the promotion identification information 300b of the main item 300a selected by the user, and identifies additional items 301a having the same promotion identification information 301b as the value of the corresponding promotion identification information 300b. The electronic apparatus according to some example embodiments may provide the user with the information on the additional items 301a related to the main item together with the information on the main item 300a selected by the user.

For example, referring to FIG. 3, when the user selects the item X 300a as the main item, the electronic apparatus according to some example embodiments checks information on the item X 300a. The electronic apparatus according to some example embodiments may check the promotion identification information 300b of the item X 300a and inquire about other items 301a having the promotion identification information ‘123’. The electronic apparatus according to some example embodiments checks information about the inquired other additional items Y and Z 301a. The electronic apparatus according to some example embodiments provides the user with the first page containing information on the item X 300a and information on other additional items Y and Z 301a.

The electronic apparatus according to some example embodiments may classify and store some or all of the items having the same promotion identification information into one bundle group. For example, in FIG. 3, items X, Y, and Z having the same promotion identification information may be classified into the same bundle group and stored in the electronic apparatus according to example embodiments.

The bundle group may be, for example, a group including items having the same promotion identifier, or a group including only some of the items having the same promotion identifier. A bundle group may represent, for example, a set of items that are structurally similar to one specific item but have different properties (e.g., color, size, etc.). For example, with respect to a cell phone case item, a white cell phone case, a black cell phone case, a gray cell phone case, etc. may all be items included in the same bundle group.

The bundle group according to some example embodiments may be identified by a bundle ID. Also, several items included in the bundle group according to some example embodiments may be identified by a vendor item ID. The vendor item ID may be information on the item possessed by each item.

That is, when the user selects the main item 300a, the electronic apparatus according to some example embodiments identifies the bundle group 302 to which the main item 300a selected by the user belongs, and identifies other additional items 302a included in the corresponding bundle group 302. The bundle group 302 may be distinguished or identified by, for example, bundle identification information. That is, the bundle identification information may be identification information for distinguishing items having the same promotion identification information value.

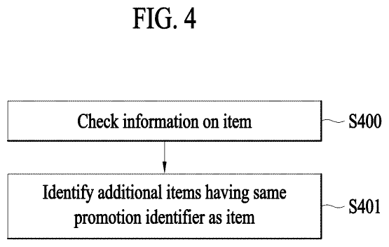

FIG. 4 is a flowchart illustrating an example of a method of providing item information according to example embodiments.

Some or all operations shown in FIG. 4 may be performed in the electronic apparatus according to some example embodiments shown in FIGS. 1 to 3. Referring to FIG. 4, the apparatus for providing item information according to some example embodiments may perform some or all of operations S400 to S401. Hereinafter, the apparatus for providing item information according to some example embodiments will be referred to as the electronic apparatus according to example embodiments.

Referring to operation S400, the electronic apparatus according to some example embodiments may check information on a main item. Operation S400 may include some or all operations in S200 shown in FIG. 2.

Referring to operation S401, the electronic apparatus according to some example embodiments may identify additional items having the same promotion identifier as the item. Operation S400 may include at least one of operations S201 to S203 shown in FIG. 2.

Operation S401 may include, for example, at least one of checking promotion identification information related to the main item and checking at least one additional item having promotion identification information corresponding to the promotion identification information.

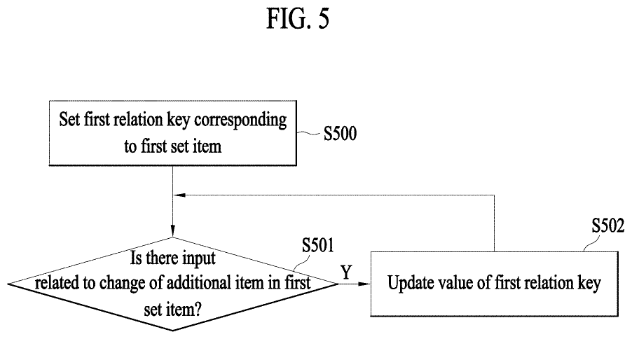

FIG. 5 is a flowchart illustrating an example of a method of providing item information according to example embodiments.

Some or all operations shown in FIG. 5 may be performed in the electronic apparatus according to some example embodiments shown in FIGS. 1 to 4.

Specifically, FIG. 5 illustrates an operation that the electronic apparatus according to some example embodiments generates relation identification information in units of items or sets of items so that a user can manage and purchase selected main items and additional items in units of sets. The relation identification information according to some example embodiments shown in FIG. 5 may be the relation identification information described with reference to FIG. 2.

In the above-described configuration, the user may separately purchase or separately manage the main item and the additional items through the electronic apparatus according to example embodiments, but may also manage the main item and the additional items as one set. Accordingly, the electronic apparatus according to some example embodiments may manage a plurality of items as a set, thereby providing a convenient purchase procedure to the user.

Referring to FIG. 5, the apparatus for providing item information according to some example embodiments may perform some or all of operations S500 to S502. Hereinafter, the apparatus for providing item information according to some example embodiments will be referred to as the electronic apparatus according to example embodiments.

Referring to operation S500, the electronic apparatus according to some example embodiments may set first relation identification information corresponding to a first set item. The set item may be a set of items including a main item that the user wants to purchase and one or more additional items. The apparatus for providing item information according to some example embodiments may generate or set the first relation identification information of the first set item that is distinguished from an identifier for identifying an item (e.g., an item identifier, etc.) in order for a user to manage the item in a set unit.

The item information providing apparatus according to some example embodiments separates the relation identification information and the identifier for identifying the item to provide the user with a convenient management function by separately treating the case of purchasing an item individually and the case of purchasing the item in bundle with other items. That is, the relation identification information according to some example embodiments may be identification information for identifying a set of items (i.e., a set item).

Further, when an item included in one set is changed, the electronic apparatus according to some example embodiments should change (update) the relation identification information for the corresponding set. For example, the set item including the main item and the first additional item is a different set from the set item including the main item and the second additional item.

Accordingly, referring to operation S501, the electronic apparatus according to some example embodiments may check an input related to a change of an additional item in the first set item. Referring to operation S502, the electronic apparatus according to some example embodiments may update the value of the first relation identification information.

For the change of the additional item, there may be cases, for example, where the additional item included in the first set item is changed to another item, where the number of the additional items included in the first set item is changed, and the additional item included in the first set item is deleted.

For example, when the first set item included one main item and two first additional items, and the first additional item is deleted or the number is changed by a user input, the electronic apparatus according to some example embodiments may change (update) the value of the first relation information. Similarly, when the second additional item is added by the user's input, the value of the first relation information is changed.

In this configuration, the electronic apparatus according to some example embodiments may avoid confusion for users who want to purchase items in bulk in a set unit, and reduce the inconvenience of the user in calculating and determining the quantity of individual items one by one. Therefore, it is possible to prevent a purchase caused by a user's mistake.

In this configuration, the electronic apparatus according to some example embodiments may provide necessary information on items to the user without the user inquiring or searching for other items related to a specific item individually, thereby reducing unnecessary burden on the user and eliminating the user's inconvenience.

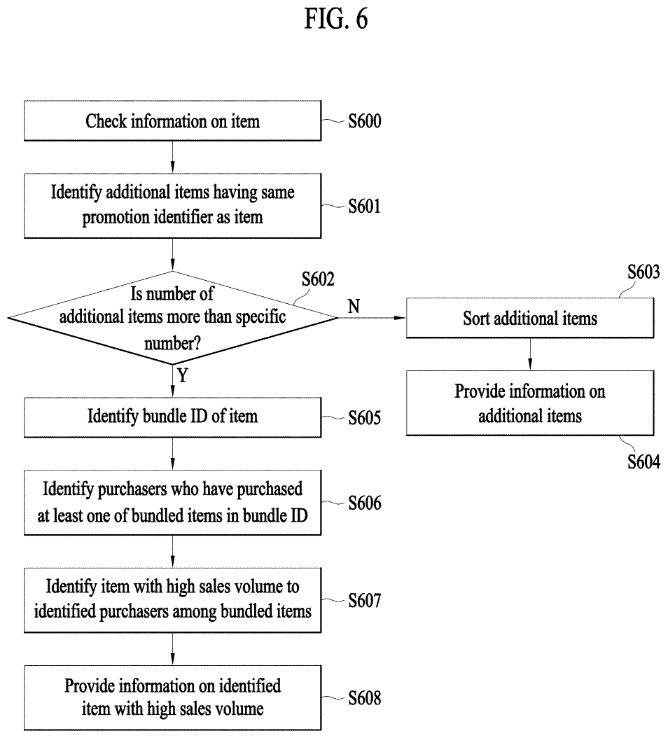

FIG. 6 is a flowchart illustrating an example of a method of providing item information according to example embodiments.

Some or all operations shown in FIG. 6 may be performed in the electronic apparatus according to some example embodiments shown in FIGS. 1 to 5.

Specifically, FIG. 6 illustrates an operation in which an electronic apparatus according to some example embodiments selects some of the additional items to present to the user in order of suitable or important items among the additional items for the main item.

Referring to FIG. 6, the electronic apparatus according to some example embodiments may perform some or all of operations S600 to S608.

Referring to operation S600, the electronic apparatus according to some example embodiments checks information on an item. Referring to operation S601, additional items having same promotion identifier as the item are identified. Operations S600 to S601 may include some or all operations shown in FIG. 4.

Referring to operation S602, the electronic apparatus according to some example embodiments may check whether the number of the additional items is more than a specific number. The specific number may be, for example, a value preset by the system or a value set by a user.

For example, when the number of the identified additional items is excessively large, the electronic apparatus according to some example embodiments may need to present only some additional items to users, and present items that the user is likely to purchase among the additional items.

Accordingly, when the number of the identified additional items is greater than or equal to the specific number, the electronic apparatus according to some example embodiments selects and presents only some of the additional items. Meanwhile, the electronic apparatus according to some example embodiments may select some of the additional items according to various criteria or arrange and present the additional items according to various criteria to the user.

For example, the electronic apparatus according to some example embodiments may present the additional items for the main item in the order of items with high sales volume. For example, when the main item is a mobile phone and the sales volume of items having the same promotion identifier as the mobile phone is large in the order of a cell phone case item, a charger item, and a liquid crystal film item, the electronic apparatus according to some example embodiments may present the additional items in the order of a cell phone case item, a charger item, and a liquid crystal film item.

Also, for example, the electronic apparatus according to some example embodiments may present the additional items in the order of applied discounts, or selects a specific number of additional items to which discounts are applied, when purchasing together with the main item among the additional items. For example, the electronic apparatus according to some example embodiments may present items that other purchasers who have purchased the corresponding main item have purchased together a lot among the additional items. For example, if the main item is a mobile phone, and when purchasing the mobile phone, 30% discount is applied to the purchase of a cell phone case item, 50% to the purchase of a charger item, and 20% to the purchase of a liquid crystal film item, the electronic apparatus according to some example embodiments may present the additional items to the user by exposing the additional items in the order of the charger, the cell phone case, and the liquid crystal film. Accordingly, referring to FIG. 6, when the number of the identified additional items is greater than or equal to a specific number, the electronic apparatus may perform at least one of operation S603 for sorting the additional items and operation S604 for providing information on the additional items corresponding to the specific number among the additional items based on the sorted result.

Referring to operation S603, the electronic apparatus according to some example embodiments may sort the additional items in the order of discounts applied when purchasing together with the main item, or in the order of quantities of items purchased by other buyers who purchased the main item.

Also, referring to FIG. 6, when the number of the identified additional items is smaller than the specific number, the electronic apparatus according to some example embodiments may perform at least one of operations S605 to S608.

For example, the electronic apparatus according to some example embodiments may check bundle identification information of the main item selected by the user, and may select additional items in the order (or representative) of items with the highest sales volume from the bundle items. That is, the electronic apparatus according to some example embodiments may present the additional items to the user in the order of most sold items by other users, or may present the additional items with high sales volume as representatives to the user, within the bundle group of the items the user wants to purchase. The bundle identification information may be identification information for distinguishing items having the same promotion identification information value. A bundle group may represent a set of items that are structurally similar to one specific item but have different properties (e.g., color, size, etc.).

That is, for example, with respect to a cell phone case item, a white cell phone case, a black cell phone case, a gray cell phone case, etc. may all be items included in the same bundle group. If the sales volume of the black cell phone case item is the highest, the electronic apparatus according to some example embodiments may present the black cell phone case item among the cell phone case items of various colors included in the bundle group as a representative for the cell phone case item to the user. Meanwhile, several items included in a bundle group according to some example embodiments may be identified by a vendor item ID. The vendor item ID may be information on the item possessed by each item.

Accordingly, referring to operation S605, the electronic apparatus according to some example embodiments may check bundle identification information of the item. The bundle identification information may be, for example, the bundle identification information described with reference to FIGS. 2 and 3. Referring to operation S606, the electronic apparatus according to some example embodiments may identify purchasers who have purchased at least one of items in the corresponding bundle group (bundled items). Referring to operation S607, the electronic apparatus according to some example embodiments may identify items with high sales volume to the identified purchasers among the bundled items. Referring to operation S608, the electronic apparatus according to some example embodiments may provide information on additional items as much as a specific number among the items with high sales volume. The specific number may be five, or more or less. Also, for example, the electronic apparatus may present only one representative item among the items included in the bundle group to the user. In this case, the specific number may be one.

By presenting only some of the additional items for a specific main item to the user based on the user's preference or sales volume, the electronic apparatus according to some example embodiments may effectively suggest to the user which additional items to purchase and which benefits can be obtained if purchased together with the main item.

In addition, the electronic apparatus according to some example embodiments may provide additional items most suitable to the user by presenting the additional items to the user based on priorities, and may promote the user's item purchase rate and demand intention.

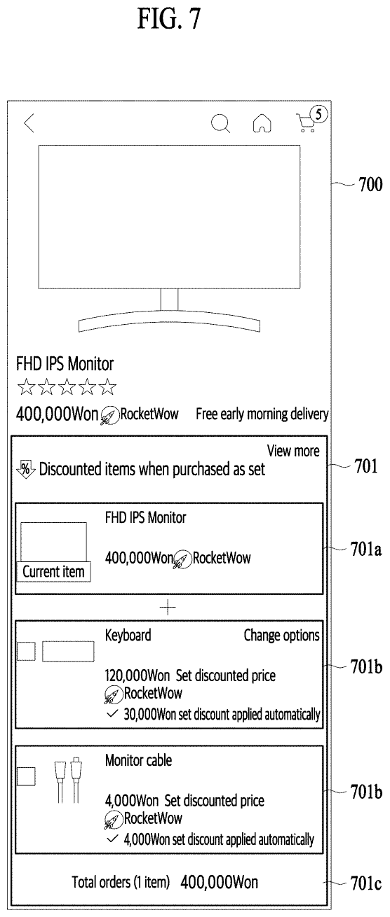

FIG. 7 shows an example of a first page according to example embodiments.

A first page 700 according to some example embodiments shown in FIG. 7 may be a page for displaying detailed descriptions of a main item according to example embodiments. The first page 700 may be variously called an item detail page, a product detail page, a product information page, and the like. The first page 700 according to some example embodiments may be the first page described with reference to FIGS. 1 to 4.

The first page 700 according to some example embodiments may contain a description of the main item (e.g., information about an image or video of the main item, a name of the main item, a price of the main item, etc.).

The first page 700 according to some example embodiments may include a first area 701 displaying additional items related to the main item. That is, the first area 701 displays additional items to which a discount benefit can be applied when the user purchases together with the main item, and may include information on the additional items. The first area 701 may be referred to as an area for items discounted when purchased as a set, an additional item area, a related item area, and the like.

The first area 701 according to some example embodiments may include, for example, a first sub-area 701a containing a brief description of the main item, and a second sub-area 701b containing information on each additional item. The first sub-area 701a contains information about the main item. The first sub-area 701a may contain a name of the main item, a price of the main item, and a category of the main item. The second sub-area 701b may include a name of the corresponding additional item, a price of the corresponding additional item, and a category of the corresponding additional item.

The second sub-area 701b may contain information indicating the price of the corresponding additional item, or may include discount information applied to the corresponding additional item. For example, the second sub-area 701b may indicate how much discount is applied when the user purchases the corresponding additional item together with the main item.

The second sub-area 701b may include an input interface for displaying whether the user will purchase the corresponding additional item. The input interface may be, for example, a check box. That is, when the user clicks on the corresponding input interface, the electronic apparatus according to some example embodiments may confirm that the user will purchase the corresponding additional item as a set together with the main item.

The electronic apparatus according to some example embodiments may configure one item set by including the first additional item with the main item in response to the user clicking the corresponding input interface to add the first additional item.

Further, the first area 701 according to some example embodiments may further contain information indicating a total price obtained by summing the price of the main item and the prices of additional items added by the user. The total price may be the sum of the price of the main item and the prices of additional items to which discounts are applied.

The first area 701 in the first page 700 according to some example embodiments may display a specific number of additional items. That is, the first area 701 may include a specific number of second sub-areas 701b. The first area 701 according to some example embodiments may further include an interface for providing all additional items to the user.

In order to configure a set including the main item and the first additional item, the electronic apparatus according to some example embodiments may set relation identification information corresponding to the set. The electronic apparatus according to some example embodiments may update the value of the set relation identification information in response to addition or deletion of an additional item.

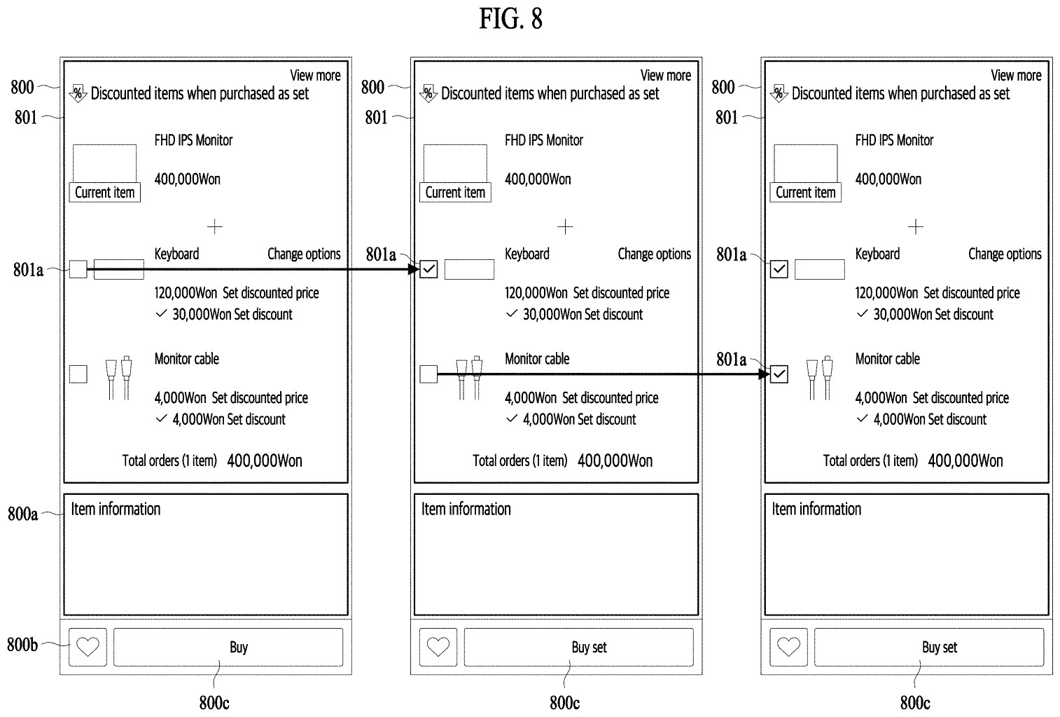

FIG. 8 shows an example of a first page according to example embodiments.

A first page 800 according to some example embodiments shown in FIG. 8 may be the first page described with reference to FIGS. 1 to 7. The first page 800 according to some example embodiments may include a second sub-area 801 according to example embodiments. The second sub-area 801 may be the second sub-area 702 described with reference to FIG. 7.

The first page 800 according to some example embodiments may further include a third area 800a displaying detailed information of the main item, a second interface 800b for adding the main item and the additional item(s) selected by the user to an item list (e.g., shopping cart list), and a third interface 800c for purchasing the main item and the additional item(s) selected by the user. The item list may be, for example, a shopping cart list or a wish list.

The second sub-area 801 may include an input interface 801a for indicating whether the user will purchase the corresponding additional item. The input interface 801a may be, for example, a check box. That is, when the user clicks the corresponding input interface 801a, the electronic apparatus according to some example embodiments may confirm that the user will purchase the corresponding additional item together with the main item as a set.

For example, if the user does not click the input interface 801a for any additional item, the second sub-area 801 of the first page 800 may display only the price information 801b-1 of the main item. Here, the third interface 800c according to some example embodiments may be indicated as ‘Buy’.

For example, when the user clicks on the input interface 801a for the first additional item, the second sub-area 801 of the first page 800 may display the first price 801b-2 that is a sum of the price of the main item and the price of the first additional item. The second sub-area 801 may also display a price related to a discount applied when purchasing the first additional item, together with the first price 801b-2. The second sub-area 801 may display information related to the total number of selected items along with the first price 801b-2 and the price related to the discount. Here, in response to the user clicking the input interface 801a for the first additional item, the third interface 800c according to some example embodiments may be indicated as ‘Buy a set’ because the object the user wants to purchase is a set of items rather than individual items. Also, the electronic apparatus according to some example embodiments may set an item set including the main item and the first additional item, and may set relation identification information to set or identify the item set. That is, the electronic apparatus according to some example embodiments may change information indicated on the third interface 800c related to purchase in response to confirmation of the selected one or more additional items.

Furthermore, when the user clicks the input interface 801a for the second additional item, the second sub-area 801 may display a second price 801b-3 that is a sum of the price of the main item, the price of the first additional item, and the price of the second additional item. The second sub-area 801 may display a price related to a discount applied when purchasing the first additional item and the second additional item, together with the second price 801b-3. The second sub-area 801 may display information related to the total number of selected items along with the second price 801b-3 and the price related to the discount. Here, the third interface 800c according to some example embodiments may be indicated as ‘Buy a set’ because the object the user wants to purchase is a set of items rather than individual items. Also, the electronic apparatus according to some example embodiments may set an item set including the main item, the first additional item, and the second additional item, and may update the relation identification information.

The electronic apparatus according to some example embodiments may set the relation identification information for identifying a set item including the main item and additional items selected by the user, in response to the user's input of the second interface 800b or the third interface 800c. The electronic apparatus according to some example embodiments may provide a second page for a procedure for purchasing the corresponding set item and may provide a fourth area for the purchase procedure of the set item displayed on the first page 800, in response to an input of the third interface 800c.

The electronic apparatus according to some example embodiments may provide the user's terminal with a second page for purchasing a plurality of set items including the set item. Here, the second page may discriminate and display set items having different relation key values. Also, on the second page, information related to delivery of items according to some example embodiments may be displayed separately for each item. Due to this configuration, the electronic apparatus according to some example embodiments can efficiently manage the purchase of a set item by displaying information about each item (delivery information, etc.) to the user by discriminating each set.

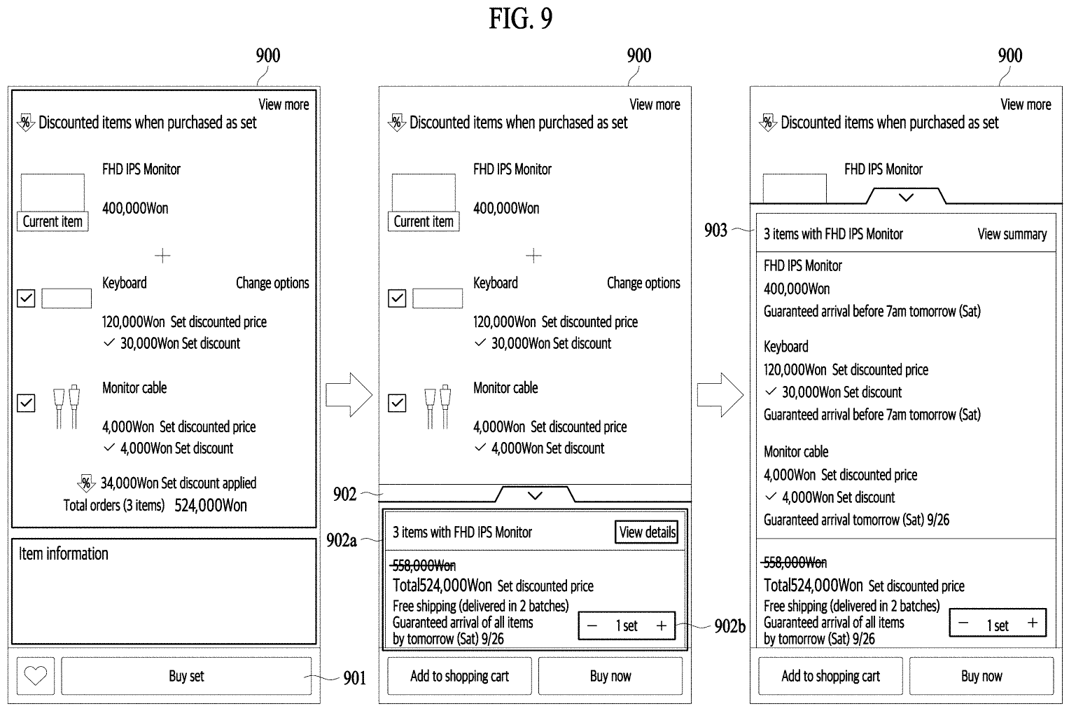

FIG. 9 shows an example of a first page according to example embodiments.

A first page 900 according to some example embodiments shown in FIG. 9 may be the first page described with reference to FIGS. 1 to 8. The first page 900 according to some example embodiments may include at least one of the first area, the second area and the third area, according to some example embodiments described with reference to FIGS. 7 and 8, and a third interface 901.

The electronic apparatus according to some example embodiments may provide a second page for a procedure for purchasing the corresponding set item or may provide a fourth area 902 for the purchase procedure of the set item displayed on the first page 900, in response to an input of the third interface 901.

The fourth area 902 may be an area displayed on the first page according to example embodiments. The fourth area 902 may be an area that is slid up from the bottom of the first page 900 in response to an input of the third interface 901. The fourth area 902 may be an area overlaid on the first page 900.

The fourth area 902 according to some example embodiments may contain information 902a on a set item selected by a user (i.e., a set item corresponding to relation identification information set by the electronic apparatus).

The information 902a on the set item may include, for example, a total sum of the price of the main item included in the set and the price of at least one additional item, and a set discount price to which the set discount according to some example embodiments is applied to the total sum of the price. The information 902a on the set item may further include, for example, information related to delivery of the set item and a fourth interface 902b for setting a purchase quantity of the corresponding set item.

The fourth area 902 according to some example embodiments may further include a fifth interface for providing detailed purchase information for purchasing the set selected by the user. The electronic apparatus according to some example embodiments provides detailed information on items included in the set in response to an input of the fifth interface.

For example, in response to the input of the fifth interface, the electronic apparatus according to some example embodiments may provide the user with a price of each item in the set item, information related to a discount applied to each item (e.g., a discounted price applied to the corresponding item, degree of discount, etc.), information related to delivery of each item, and a name of each item. The electronic apparatus according to some example embodiments may enlarge the fourth area 902 in response to the input of the fifth interface. Also, the information related to delivery of items according to some example embodiments may be displayed separately for each item. In this configuration, the electronic apparatus according to some example embodiments enables the user to efficiently manage the purchase of a set item by displaying the information on each item (delivery information, etc.) for each set.

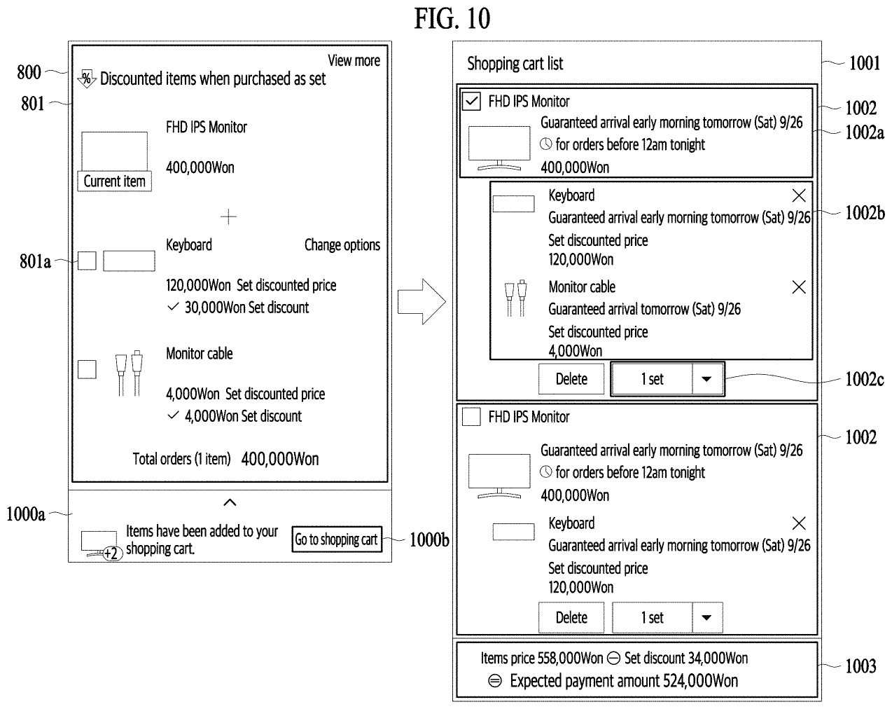

FIG. 10 shows an example of a first page according to some example embodiments and a third page showing a shopping cart list according to example embodiments.

Referring to FIG. 10, a left portion of FIG. 10 shows an example of a first page 1000 according to example embodiments. The first page 1000 according to some example embodiments means the first page described with reference to FIGS. 1 to 9. The first page 1000 according to some example embodiments may include a first area, second area, third area, and third interface according to example embodiments. The first area, second area, third area, and third interface may be the first area, second area, third area, and third interface, respectively, according to some example embodiments described with reference to FIGS. 7 to 9.

In response to the user's input of the second interface, the first page 1000 according to some example embodiments may display a fifth area 1000a for indicating that the set item selected by the user has been added to the shopping cart list. The fifth area 1000a may include a sixth interface 1000b for providing a second page 1001 displaying items included in the user's shopping cart list.

In response to an input of the sixth interface 1000b, the electronic apparatus according to some example embodiments provides the second page 1001 displaying items included in the user's shopping cart list. The second page 1001 displays item(s) and set item(s) included in the user's shopping cart list.

The electronic apparatus according to some example embodiments discriminately displays an item and a set item by using the relation identification information according to example embodiments. That is, even though the main item is the same, sets having different configurations of additional items are managed separately from each other, so the electronic apparatus according to some example embodiments displays the different sets and items in the sixth areas 1002 separated from each other in the second page 1001. The electronic apparatus according to some example embodiments separates different sets by using the relation identification information of the set items and displays them on the second page 1001.

The sixth area 1002 displays information about discriminated items or set items. The sixth area 1002 includes a third sub-area 1002a displaying information on the main item of the set item and a fourth sub-area 1002b displaying information on additional items of the set item. The third sub-area 1002a and the fourth sub-area 1002b include names of corresponding items, information related to discounts of the corresponding items, and images or videos representing the corresponding items. The sixth area 1002 may include an interface for deleting the corresponding set from the shopping cart list and an interface 1002c for setting the number of the corresponding set.

The fourth sub-area 1002b according to some example embodiments may be displayed smaller than the third sub-area 1002a or may be displayed below the third sub-area 1002a.

The second page 1001 according to some example embodiments may further include an interface (e.g., a check box) for selecting an item or a set item corresponding to each sixth area 1002.

The second page 1001 according to some example embodiments may further include a seventh area 1003 displaying price information for purchasing an item or an item set selected by the user in the shopping cart list. The seventh area 1003 may contain information indicating a total price of the item or item set selected by the user to which a discount is not applied (total sum of the price of items), a total price to which the discount of the item or item set selected by the user is applied (expected payment amount), and information indicating a set discount price. The set discount price may be a price obtained by subtracting the expected payment amount from the total sum of the price of items.

Example embodiments of the present disclosure have been disclosed in the present specification and drawings. Although specific terms are used, these are only used in general meaning to easily explain the technical content of the present disclosure and to aid understanding of the present disclosure, but not intended to limit the scope of the present disclosure. It is obvious to those skilled in the art that other modified examples based on the technical idea of the present disclosure can be implemented in addition to the example embodiments disclosed herein.

The electronic apparatus or terminal according to the above-described example embodiments may include a processor, a memory for storing and executing program data, a permanent storage such as a disk drive, a communication port for communicating with an external device, a user interface device such as a touch panel, a key, a button, or the like. Methods implemented as software modules or algorithms may be stored on a computer-readable recording medium as computer-readable codes or program instructions executable on the processor. Here, the computer-readable recording medium includes a magnetic storage medium (e.g., ROM (read-only memory), RAM (random-Access memory), floppy disk, hard disk, etc.) and optical reading medium (e.g., CD-ROM and DVD (Digital Versatile Disc)). The computer-readable recording medium is distributed over networked computer systems, so that computer-readable codes can be stored and executed in a distributed manner. The medium is readable by a computer, stored in a memory, and executed on a processor.

The present example embodiment can be represented by functional block configurations and various processing steps. These functional blocks may be implemented with various numbers of hardware or/and software configurations that perform specific functions. For example, the example embodiment may employ an integrated circuit configuration such as memory, processing, logic, look-up table, or the like, capable of executing various functions by control of one or more microprocessors or other control devices. Similar to that components can be implemented with software programming or software elements, this example embodiment includes various algorithms implemented with a combination of data structures, processes, routines or other programming components and may be implemented with a programming or scripting language including C, C++, Java, assembler, etc. Functional aspects can be implemented with an algorithm running on one or more processors. In addition, the present example embodiment may employ a conventional technique for at least one of electronic environment setting, signal processing, and data processing. Terms such as “mechanism”, “element”, “means”, and “composition” can be used in a broad sense, and are not limited to mechanical and physical configurations. Those terms may include the meaning of a series of routines of software in connection with a processor or the like.

The above-described example embodiments are merely examples, and other embodiments may be implemented within the scope of the claims to be described later.

Example embodiments of the present disclosure have been disclosed in the present specification and drawings. Although specific terms are used, these are only used in general meaning to easily explain the technical content of the present disclosure and to aid understanding of the present disclosure, but not intended to limit the scope of the present disclosure. It is obvious to those skilled in the art that other modified examples based on the technical idea of the present disclosure can be implemented in addition to the example embodiments disclosed herein.

1. A method of providing item information of an electronic apparatus, the method comprising:
storing, in a database, items and identifiers, wherein:
each item is associated with one or more identifiers,
the identifiers identify bundle groups of items, and
discount information related to purchase of multiple items which are members of a common bundle group;
receiving, as a first input, a user selection of a main item;
obtaining, from the database, first information on the main item, of the items, wherein the first information comprises an identifier, of the identifiers, associated with the main item;
querying, based on the identifier, the database for at least one additional item;
receiving, from the database and based on a result of querying the database with the identifier, at least one additional item, wherein the at least one additional item is related, by the identifier, to the main item by being a member of a first bundle group, wherein the identifier of the at least one additional item matches the identifier of the main item;
obtaining, from the database, second information on the at least one additional item of the first bundle group;
providing, to a terminal of a user, a first page including a first area containing the first information on the main item, a second area containing the second information on the at least one additional item, and a third area containing a first interface related to item purchase;
identifying one or more additional items selected from the at least one additional item based on a second input corresponding to the second area;
providing, based on a third input corresponding to the first interface, third information related to a purchase of a first item set, wherein the first item set comprises the main item and the selected one or more additional items of the first bundle group;
providing, to the terminal of the user, a second page for a purchase of a plurality of item sets including the first item set, wherein the plurality of item sets have set identification information values to be discriminated from each other, and wherein each item set of the plurality of item sets includes at least the main item and one or more of the at least one additional item of the first bundle group; and
receiving a selection of one of the plurality of item sets,
wherein the at least one additional item is related to the main item based on a matching identifier.

2. The method of claim 1, further comprising:
changing information displayed on the first interface related to the purchase in response to the identification of the selected one or more additional items.

3. The method of claim 1, wherein the third information related to the purchase of the first item set includes information related to delivery of items in the first item set, and the information related to the delivery of the items is displayed separately for each item.

4. The method of claim 1, wherein the third information related to the purchase of the first item set is displayed in a fourth area displayed on the first page, and
the fourth area includes a second interface for payment of the first item set and a third interface for adding the first item set to a cart list.

5. The method of claim 1, wherein the receiving the at least one additional item comprises:
checking promotion identification information related, via the identifier, to the main item; and
identifying the at least one additional item having promotion identification information corresponding to the promotion identification information.

6. The method of claim 1, further comprising:
setting set identification information corresponding to the first item set including the main item and the selected one or more additional items in response to the third input.

7. The method of claim 6, wherein a value of the set identification information is updated in response to a fourth input related to change of the selected one or more additional items by a user, and
a different set identification information value is set in response to a fifth input related to a different item set.

8. (canceled)

9. The method of claim 1, wherein the first item set is added to a shopping cart list based on the set identification information, in response to a sixth input of a user.

10. The method of claim 1, wherein the first page includes a selection interface for selecting each additional item.

11. The method of claim 9, further comprising:
providing the terminal of the user with a third page for displaying one or more item sets included in the shopping cart list in response to a seventh input,
wherein the third page displays the one or more item sets having different relation key values to be discriminated.

12. The method of claim 1, wherein the second page includes first information indicating a first price that is a sum of a price of the main item and a price of the at least one additional item, and second information indicating a second price to which a set discount is applied to the first price.

13. The method of claim 12, wherein the second page further includes third information indicating a difference between the first price and the second price.

14. The method of claim 8, wherein the second page includes an interface for the user to adjust a purchase quantity of the first item set.

15. The method of claim 1, wherein the second information on the at least one additional item includes information indicating a price to which a discount applied at a time of purchase for each additional item is applied.

16. The method of claim 1, wherein the first page displays the at least one additional item to be arranged in a specific order, and the specific order is determined based on a degree of a discount applied at a time of purchase for each additional item.

17. The method of claim 5, further comprising:
checking bundle identification information for discriminating items having the same promotion identification information;
identifying at least one representative item based on a sales volume of the items included in the bundle identification information; and
providing a terminal of a user with the at least one representative item.

18. An electronic apparatus for providing item information, the electronic apparatus comprising:
a database configured to store items and identifiers, wherein:
each item is associated with one or more identifiers,
the identifiers identify bundle groups of items, and
discount information related to purchase of multiple items which are members of a common bundle group; and
a processor,
wherein the processor is configured to:
receive, as a first input, a user selection of a main item;
obtain, from the database, first information on the main item, of the items, wherein the first information comprises an identifier, of the identifiers, associated with the main item;
query, based on the identifier, the database for at least one additional item;
receive, from the database and based on a result of querying the database with the identifier, at least one additional item, wherein the at least one additional item is related, by the identifier, to the main item by being a member of a first bundle group, wherein the identifier of the at least one additional item matches the identifier of the main item;
obtain, from the database, second information on the at least one additional item of the first bundle group;
provide, to a terminal of a user, a first page including a first area containing the first information on the main item, a second area containing the second information on the at least one additional item, and a third area containing a first interface related to item purchase;
identify one or more additional items selected from the at least one additional item based on a second input corresponding to the second area;
provide, based on a third input corresponding to the first interface, third information related to a purchase of a first item set, wherein the first item set comprise the main item and the selected one or more additional items of the first bundle group;
provide, to the terminal of the user, a second page for a purchase of a plurality of item sets including the first item set, wherein the plurality of item sets have set identification information values to be discriminated from each other, and wherein each item set of the plurality of item sets includes at least the main item and one or more of the at least one additional item of the first bundle group; and
receive a selection of one of the plurality of item sets,
wherein the at least one additional item is related to the main item based on a matching identifier.

19. A non-transitory computer-readable storage medium comprising:
a medium configured to store computer-readable instructions,
wherein, when the computer-readable instructions are executed by a processor, the processor is configured to perform:
storing, in a database, items and identifiers, wherein:
each item is associated with one or more identifiers,
the identifiers identify bundle groups of items, and
discount information related to purchase of multiple items which are members of a common bundle group;
receiving, as a first input, a user selection of a main item;
obtaining, from the database, first information on the main item, of the items, wherein the first information comprises an identifier, of the identifiers, associated with the main item;
querying, based on the identifier, the database for at least one additional item;
receiving, from the database and based on a result of querying the database with the identifier, at least one additional item, wherein the at least one additional item is related, by the identifier, to the main item by being a member of a first bundle group, wherein the identifier of the at least one additional item matches the identifier of the main item;
obtaining, from the database, second information on the at least one additional item of the first bundle group;
providing, to a terminal of a user, a first page including a first area containing the first information on the main item, a second area containing the second information on the at least one additional item, and a third area containing a first interface related to item purchase;
identifying one or more additional items selected from the at least one additional item based on a second input corresponding to the second area;
providing, based on a third input corresponding to the first interface, third information related to a purchase of a first item set, wherein the first item set comprises the main item and the selected one or more additional items of the first bundle group;
providing, to the terminal of the user, a second page for a purchase of a plurality of item sets including the first item set, wherein the plurality of item sets have set identification information values to be discriminated from each other, and wherein each item set of the plurality of item sets includes at least the main item and one or more of the at least one additional item of the first bundle group; and
receiving a selection of one of the plurality of item sets,
wherein the at least one additional item is related to the main item based on a matching identifier.
